(19) United States
(12) Patent Application Publication
(10) Pub. No.: US 2008/0233479 A1
(43) Pub. Date: Sep. 25, 2008

(54) NEGATIVE ACTIVE MATERIAL FOR RECHARGEABLE LITHIUM BATTERY AND RECHARGEABLE LITHIUM BATTERY INCLUDING SAME

(76) Inventors: Min-Seok Sung, Yongin-si (KR); Yang-Soo Kim, Yongin-si (KR); Goo-Jin Jeong, Yongin-si (KR); Yong-Mook Kang, Yongin-si (KR); Sang-Min Lee, Yongin-si (KR); Wan-Uk Choi, Yongin-si (KR); Sung-Soo Kim, Yongin-si (KR)

Correspondence Address: CHRISTIE, PARKER & HALE, LLP, PO BOX 7068, PASADENA, CA, 91109-7068, US

(21) Appl. No.: 12/049,136

(22) Filed: Mar. 14, 2008

(30) Foreign Application Priority Data
Mar. 21, 2007 (KR) 10-2007-0027775

(51) Int. Cl. H01M 4/38; H01M 4/42

(52) U.S. Cl. 429/220; 429/218.1; 429/223; 429/221; 429/231.5; 429/224; 429/229

(57) ABSTRACT

Negative active materials for rechargeable lithium batteries are provided. One negative active material includes at least one Si active particle and a metal matrix surrounding the Si active particle. The metal matrix does not react with the Si active particle. The negative active material has a martensite phase when X-ray diffraction intensity is measured using a CuKα ray. The negative active material has improved efficiency and cycle-life.

### CROSS-REFERENCE TO RELATED APPLICATION

This application claims priority to and the benefit of Korean Patent Application No. 10-2007-0027775 filed in the Korean Intellectual Property Office on Mar. 21, 2007, the entire content of which is incorporated herein by reference.

### BACKGROUND OF THE INVENTION

1. Field of the Invention

The present invention relates to negative active materials for rechargeable lithium batteries and rechargeable lithium batteries including the same.

2. Description of the Related Art

Rechargeable lithium batteries use materials that are capable of reversibly intercalating or deintercalating lithium ions as the positive and negative electrodes. Organic electrolyte solutions or polymer electrolytes may be used between the positive and negative electrodes. Rechargeable lithium batteries generate electrical energy by oxidation/reduction reactions occurring during intercalation/deintercalation of lithium ions at the positive and negative electrodes.

As positive active materials, chalcogenide compounds have been widely used. Composite metal oxides such as LiCoO₂, LiMn₂O₄, LiNiO₂, LiNi₁₋ₓCOₓO₂ (0<x<1), LiMnO₂, and so on, have also been used.

Conventionally, lithium metals have been used as negative active materials for rechargeable lithium batteries. However, when using lithium metal, dendrites can form which can cause short circuits, which, in turn, can cause explosions. Therefore, carbonaceous materials, such as amorphous carbon and crystalline carbon, have recently been used as negative active materials in place of lithium metals. However, such carbonaceous materials impart irreversible capacities of from 5 to 30% during the first several cycles, which wastes lithium ions and prevents at least one active material from being fully charged and discharged. Therefore, carbonaceous negative active materials have poor energy densities.

In addition, recent research has shown that metal negative active materials such as Si, Sn, and so on, which supposedly have high capacities, impart irreversible capacity characteristics. Further, tin oxide is an alternative to carbonaceous negative active materials. However, as the metal negative active material is included at 30% or less, initial Coulomb efficiency is decreased. Further, as lithium is continuously intercalated and deintercalated to generate a lithium-metal alloy, the capacity is remarkably decreased and the capacity retention rate is remarkably deteriorated after 150 charge and discharge cycles, making it not commercially viable.

### SUMMARY OF THE INVENTION

One embodiment of the present invention provides a negative active material for a rechargeable lithium battery having improved efficiency and cycle-life.

Another embodiment of the present invention provides a rechargeable lithium battery including the negative active material.

According to an embodiment of the present invention, a negative active material for a rechargeable lithium battery includes at least one Si active particle and a metal matrix surrounding the Si active particle. The metal matrix does not react with the Si active particle. The negative active material has a martensite phase when X-ray diffraction intensity is measured using a CuKα ray.

In one embodiment, the metal matrix includes a superelastic metal alloy selected from the group consisting of Cu—Al alloys, Cu—Zn alloys, Ti—Ni alloys, and combinations thereof.

The metal matrix may further include a transition element capable of maintaining superelasticity of the superelastic metal alloy. The transition element may be selected from the group consisting of Ga, Ti, V, Cr, Mn, Fe, Co, Ni, Cu, Zn, Ru, Rh, Pd, W, Re, Os, Ir, Au, and combinations thereof.

The Si active particle and the metal matrix may be present in alloy form. The alloy may be represented by Formula 1:

xSi-y(aα-bβ-cγ) Formula 1

In Formula 1, x ranges from about 30 to about 70 atomic %, y ranges from about 30 to about 70 atomic %, x+y is 100 atomic %, α is Cu or Ti, β is Al or Zn when α is Cu, and β is Ni when α is Ti, and γ is a transition element capable of maintaining superelastic characteristics of a superelastic alloy such as Cu—Al alloys, Cu—Zn alloys, and Ti—Ni alloys. The transition element may be selected from the group consisting of Ga, Ti, V, Cr, Mn, Fe, Co, Ni, Cu, Zn, Ru, Rh, Pd, W, Re, Os, Ir, Au, and combinations thereof. In Formula 1, a+b+c is 100 atomic %, a ranges from 20 to 80 atomic %, b ranges from 80 to 20 atomic %, and c ranges from 0 to 25 atomic %.

The metal matrix may be band-shaped having an average thickness ranging from about 10 to about 100 nm.

According to one embodiment, the Si active particle has an average particle size ranging from about 10 to about 100 nm.

According to another embodiment of the present invention, a rechargeable lithium battery includes a negative electrode including the negative active material, a positive electrode including a positive active material capable of reversibly intercalating and deintercalating lithium ions, and an electrolyte.

### BRIEF DESCRIPTION OF THE DRAWINGS

FIG. 1 is a cross-sectional perspective view of a rechargeable lithium battery according to an embodiment of the present invention;

FIG. 2 is a SEM photograph (95,000 times magnification) of the negative active material prepared according to Example 1;

FIG. 3 is a SEM photograph (40,000 times magnification) of the negative active material prepared according to Example 2;

FIG. 4 is a SEM photograph (10,000 times magnification) of the negative active material prepared according to Comparative Example 1;

FIG. 5 is an optical microscope photograph (200 times magnification) of the negative active material according to Comparative Example 2;

FIG. 6 is a SEM photograph (20,000 times magnification) of the negative active material prepared according to Example 1;

FIG. 7 is a SEM photograph (50,000 times magnification) of the negative active material prepared according to Example 1 after 100 charge and discharge cycles;

FIG. 8 is a SEM photograph (11,000 times magnification) of the negative active material prepared according to Comparative Example 1 after one charge and discharge cycle;

FIG. 9 is a graph showing X-ray diffraction (XRD) measurement results of the negative active material prepared according to Example 1;

FIG. 10 is a graph showing differential scanning calorimetry (DSC) measurement results of the negative active material prepared according to Example 1;

FIG. 11 is a graph showing electrochemical characteristics of the negative active material prepared according to Example 1; and

FIG. 12 is a graph showing cycle-life characteristics of the negative active material prepared according to Example 1.

### DETAILED DESCRIPTION OF THE INVENTION

According to one embodiment of the present invention, a negative active material for a rechargeable lithium battery uses Si (which is being researched as a high-capacity negative active material). Since Si provides high battery capacity, it is being highlighted as a negative active material for rechargeable lithium batteries that require higher capacity. However, since negative active materials using Si have drastically expanded volumes, cracks can form during battery charging and discharging, thereby deteriorating the cycle life of the battery. This obstacle keeps Si from being commercially used as the negative active material in a battery.

According to one embodiment of the present invention, a negative active material includes at least one Si active particle, and a metal matrix surrounding the Si active particle. The metal matrix does not react with the Si active particle. When the X-ray diffraction strength of the negative active material is measured using a CuKα ray, it may include a martensite phase.

The metal matrix does not react with the Si active particle, but surrounds it, thereby firmly connecting each Si active particle.

According to one embodiment, the metal matrix includes a superelastic metal alloy selected from the group consisting of Cu—Al alloys, Cu—Zn alloys, Ti—Ni alloys, and combinations thereof.

The metal matrix may further include a transition element capable of maintaining the superelasticity of the superelastic metal alloy. The transition element may be selected from the group consisting of Ga, Ti, V, Cr, Mn, Fe, Co, Ni, Cu, Zn, Ru, Rh, Pd, W, Re, Os, Ir, Au, and combinations thereof.

Cu—Al alloys and Cu—Zn alloys are superelastic materials, and thus may form a metal matrix having elasticity, suppressing structural changes in the negative active material after charge and discharge.

Cu has excellent electrical conductivity, and thus electrically connects each Si active particle when the Si active particles are not decomposed, or when the negative active material has a crack. In Si—Cu—Al alloys and Si—Cu—Zn alloys, the Al and Zn react with Cu to form Cu—Al alloys or Cu—Zn alloys, suppressing Cu from reacting with Si and thereby forming a brittle compound of Cu₃Si.

In addition, Ti—Ni alloys are superelastic materials. When a Ti—Ni alloy is included in a Si-based negative active material, it may form a superelastic metal matrix band surrounding each Si particle, and impart elasticity to the negative active material, thereby suppressing structural changes in the negative active material after charge and discharge. In Si—Ti—Ni alloys, the Ti and Ni react with each other, and suppress Ti or Ni from reacting with Si, thereby forming a brittle compound.

The superelastic metal alloy may undergo a martensitic transformation, having an increased elastic area of more than 10%. The martensitic transformation occurs when a metal enters a firing transformation area and simultaneously has a sharply decreased elastic rate when a stress is applied to the metal. Accordingly, since the negative active material includes the superelastic metal alloy, structural changes after charge and discharge may be suppressed.

According to one embodiment, the negative active material is an alloy including the metal matrix and the Si active particle, and is represented by Formula 1.

xSi-y(aα-bβ-cγ) Formula 1

In Formula 1, x ranges from about 30 to about 70 atomic %, y ranges from about 30 to about 70 atomic %, x+y is 100 atomic %, α is Cu or Ti, β is Al or Zn when α is Cu, and β is Ni when α is Ti, and γ is a transition element capable of maintaining superelastic characteristics of a superelastic alloy such as Cu—Al alloys, Cu—Zn alloys, and Ti—Ni alloys. The transition element is selected from the group consisting of Ga, Ti, V, Cr, Mn, Fe, Co, Ni, Cu, Zn, Ru, Rh, Pd, W, Re, Os, Ir, Au, and combinations thereof. In Formula 1, a ranges from about 20 to about 80 atomic %, b ranges from about 20 to about 80 atomic %, c ranges from about 0 to about 25 atomic %, and a+b+c is 100 atomic %. In one embodiment, c ranges from 5 to 25 atomic %.

In Formula 1, x indicates the atomic % of the Si active particle, and y indicates the atomic % of the metal matrix in the alloy. Also, a, b, and c indicate the atomic % s of each component included in the metal matrix.

According to one embodiment of the present invention, the metal matrix may be included in the negative active material in an amount ranging from about 30 to about 70 atomic %. According to another embodiment of the present invention, the metal matrix may be included in an amount ranging from about 30 to about 50 atomic %. In other embodiments, the amount of the metal matrix may be about 35, about 40, about 45, about 50, about 55, about 60, or about 65 atomic %. In addition, the Si active particle may be included in an amount ranging from about 30 to about 70 atomic %. According to another embodiment of the present invention, the Si active particle may be included in an amount ranging from about 50 to about 70 atomic %. In other embodiments, the amount of the Si active particle may be about 35, about 40, about 45, about 50, about 55, about 60, or about 65 atomic %. When the metal matrix is included in an amount less than about 30 atomic %, it may not fully surround the Si particle as a band. On the other hand, when included in an amount greater than about 70 atomic %, it may deteriorate battery capacity.

According to one embodiment of the present invention, the metal matrix may be formed as a band with an average thickness ranging from about 10 to about 100 nm. According to another embodiment of the present invention, the metal matrix band may have an average thickness ranging from about 20 to about 50 nm. In addition, the Si active particle may have an average particle size ranging from about 10 to about 100 nm. According to another embodiment of the present invention, the Si active particle may have an average particle size ranging from about 10 to about 30 nm. When the Si active particle has an average particle size greater than about 100 nm, the metal matrix may become so thin that it may be severely transformed when it expands in volume. On the other hand, when the Si active particle has an average particle size smaller than 10 nm, it may be very difficult to fabricate the metal matrix band.

According to one embodiment of the present invention, the negative active material having the above-described structure may be prepared by mixing Si with a metal matrix, melting the mixture by arc melting at a temperature of about 1500° C. or greater, and solidifying the molten solution by rapid ribbon solidification in which a molten solution is sprayed onto a rotating copper roll. The mixture may be sufficiently molten at about 1500° C. or greater, and therefore there is no upper limit for melting. As used herein, the quenching speed is the rotation rate of the copper roll, which is between about 2000 and about 4000 rpm in one embodiment. Any solidification method may be used other than rapid ribbon solidification as long as a sufficient quenching speed is reached.

According to another embodiment of the present invention, a rechargeable lithium battery may include a negative electrode including a negative active material described above, a positive electrode, and an electrolyte.

The negative electrode may be fabricated by preparing a negative active material composition by mixing a negative active material, a binder, and optionally a conductive agent in a solvent. The composition is then applied on a negative current collector, dried and compressed. The negative electrode manufacturing method is well known.

The binder acts to bind negative active material particles together and also to bind negative active material particles to the current collector. Nonlimiting examples of suitable binders include polyvinylalcohol, carboxymethyl cellulose, hydroxypropylene cellulose, diacetylene cellulose, polyvinylchloride, polyvinylpyrrolidone, polytetrafluoroethylene, polyvinylidene fluoride, polyethylene, polypropylene, and combinations thereof.

Any electrically conductive material may be used as the conductive agent so long as it has electrical conductivity and chemical stability. Nonlimiting examples of suitable conductive agents include natural graphite, artificial graphite, carbon black, acetylene black, ketjen black, carbon fibers, metal powders, metal fibers (including copper, nickel, aluminum, silver, and so on), and conductive materials (such as polyphenylene derivatives).

One nonlimiting example of a suitable solvent is N-methylpyrrolidone.

The current collector may be selected from the group consisting of copper foils, nickel foils, stainless steel foils, titanium foils, nickel foams, copper foams, polymer substrates coated with conductive metals, and combinations thereof.

The positive electrode includes a current collector and a positive active material layer on the current collector. The positive active material layer includes a positive active material. The positive active material may include an active material capable of carrying out the electrochemical oxidation and reduction reaction, and may include a lithiated intercalation compound generally used in rechargeable lithium batteries. Nonlimiting examples of suitable lithiated intercalation compounds include the compounds represented by Formulas 2 to 26.

LiₐA_{1-b}B_{b}O₂ (0.95≦a≦1.1 and 0≦b≦0.5) Formula 2

LiₐE_{1-b}B_{b}O_{2-c}F_{c} (0.95≦a≦1.1, 0≦b≦0.5, and 0≦c≦0.05) Formula 3

LiE_{2-b}B_{b}O_{4-c}F_{c} (0≦b≦0.5, 0≦c≦0.05) Formula 4

LiₐNi_{1-b-c}Co_{b}B_{c}D_{α} (0.95≦a≦1.1, 0≦b≦0.5, 0≦c≦0.05, 0 ≦α≦2) Formula 5

LiₐNi_{1-b-c}Co_{b}B_{c}O_{2-α-}F_{α} (0.95≦a≦1.1, 0≦b≦0.5, 0≦c≦0.05, 0≦α≦2) Formula 6

LiₐNi_{1-b-c}Co_{b}B_{c}O_{2-α}F₂ (0.95≦a≦1.1, 0≦b≦0.5, 0≦c≦0.05, 0 ≦α≦2) Formula 7

LiₐNi_{1-b-c}Mn_{b}B_{c}D_{α} (0.95≦a≦1.1, 0≦b≦0.5, 0≦c≦0.05, 0≦α≦2) Formula 8

LiₐNi_{1-b-c}Mn_{b}B_{c}O_{2-α}F_{α}(0.95≦a≦1.1, 0≦b≦0.5, 0≦c≦0.05, 0 ≦α≦2) Formula 9

LiₐNi_{1-b-c}Mn_{b}B_{c}O_{2-α}F₂ (0.95≦a≦1.1, 0≦b≦0.5, 0≦c≦0.05, 0≦α≦2) Formula 10

LiₐNi_{b}E_{c}G_{d}O₂ (0.90≦a≦1.1, 0≦b≦0.9, 0≦c≦0.5, 0.001≦d≦0.1) Formula 11

LiₐNi_{b}C0_{c}Mn_{d}GₑO₂ (0.90≦a≦1.1, 0≦b≦0.9, 0≦c≦0.5, 0≦d≦0.5, 0.001≦e≦0.1) Formula 12

LiₐNiG_{b}O₂ (0.90≦a≦1.1, 0.001≦b≦0.1) Formula 13

LiₐCoG_{b}O₂ (0.90≦a≦1.1, 0.001≦b≦0.1) Formula 14

LiₐMnG_{b}O₂ (0.90≦a≦1.1, 0.001≦b≦0.1) Formula 15

LiₐMn₂G_{b}O₄ (0.90≦a≦1.1, 0.001≦b≦0.1) Formula 16

QO₂ Formula 17

QS₂ Formula 18

LiQS₂ Formula 19

V₂O₅ Formula 20

LiV₂O₅ Formula 21

LiIO₂ Formula 22

LiNiVO₄ Formula 23

Li_{(3-f)}J₂(PO₄)₃ (0<f≦3) Formula 24

Li_{(3-f)x}Fe₂(PO₄)₃ (0<f≦2) Formula 25

LiFePO₄ Formula 26

In Formulae 2 to 26, A is selected from the group consisting of Ni, Co, and Mn. B is selected from the group consisting of Al, Ni, Co, Mn, Cr, Fe, Mg, Sr, V, rare earth elements, and combinations thereof. D is selected from the group consisting of O, F, S, P, and combinations thereof. E is selected from the group consisting of Co, Mn, and combinations thereof. F is selected from the group consisting of F, S, P, and combinations thereof. G is selected from the group consisting of Al, Cr, Mn, Fe, Mg, La, Ce, Sr, V, and combinations thereof. Q is selected from the group consisting of Ti, Mo, Mn, and combinations thereof. I is selected from the group consisting of Cr, V, Fe, Sc, Y, and combinations thereof. J is selected from the group consisting of V, Cr, Mn, Co, Ni, Cu, and combinations thereof.

The lithiated intercalation compound may include a coating layer on its surface, or may be mixed with another lithiated intercalation compound having a coating layer. The coating layer may include at least one coating element-containing compound selected from the group consisting of coating element-containing hydroxides, coating element-containing oxyhydroxides, coating element-containing oxycarbonates, coating element-containing hydroxycarbonates, and combinations thereof. The coating element-containing compound may be amorphous or crystalline. Nonlimiting examples of suitable coating elements include at least one selected from the group consisting of Mg, Al, Co, K, Na, Ca, Si, Ti, V, Sn, Ge, Ga, B, As, Zr, and combinations thereof. The coating layer may be formed by any coating method that does not have an unfavorable effect on the properties of the positive active material. Nonlimiting examples of suitable coating methods include spray coating, and dipping. Such coating methods are well known.

The positive electrode may be fabricated by preparing a positive active material composition by mixing a positive active material, a binder, and a conductive agent in a solvent. The composition is then applied on a positive current collector.

The positive current collector may be aluminum, and the solvent may be N-methylpyrrolidone, but they are not limited thereto.

The positive electrode manufacturing method is well known.

Any electrically conductive material may be used as the conductive agent so long as it does not cause a chemical change. Nonlimiting examples of suitable conductive agents include natural graphite, artificial graphite, carbon black, acetylene black, ketjen black, carbon fiber, metal powders or metal fibers including copper, nickel, aluminum, silver, and so on, and polyphenylene derivatives.

Nonlimiting examples of suitable binders include polyvinyl alcohol, carboxymethyl cellulose, hydroxypropylene cellulose, diacetylene cellulose, polyvinylchloride, polyvinylpyrrolidone, polytetrafluoroethylene, polyvinylidene fluoride, polyethylene, and polypropylene.

The solvent may be N-methylpyrrolidone, but it is not limited thereto.

The electrolyte includes a non-aqueous organic solvent and a lithium salt. The lithium salt is dissolved in the non-aqueous organic solvent to supply lithium ions in the battery. The lithium salt performs the basic operation of the rechargeable lithium battery, and facilitates transport of the lithium ions between the positive and negative electrodes. Non-limiting examples of suitable lithium salts include electrolyte salts, such as LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(C_{y}F_{2y+1}SO₂) (where x and y are natural numbers), LiCl, LiI, and lithium bisoxalate borate. The concentration of the lithium salt may range from about 0.1 to about 2.0 M. When the concentration of the lithium salt is less than about 0.1 M, electrolyte performance is deteriorated due to its low ionic conductivity. When the concentration of the lithium salt is greater than about 2.0 M, lithium ion mobility is decreased due to an increase in electrolyte viscosity.

The non-aqueous organic solvent acts as a medium for transmitting ions taking part in the electrochemical reaction of the battery. The non-aqueous organic solvent may include a carbonate-based, an ester-based, an ether-based, a ketone-based, an alcohol-based, or aprotic solvent. Nonlimiting examples of suitable carbonate-based solvents include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and so on. Nonlimiting examples of suitable ester-based solvents may include n-methyl acetate, n-ethyl acetate, n-propyl acetate, dimethylacetate, methylpropionate, ethylpropionate, γ-butyrolactone, decanolide, valerolactone, mevalonolactone, caprolactone, and so on. Nonlimiting examples of suitable ether-based solvents include dibutyl ether, tetraglyme, diglyme, dimethoxyethane, 2-methyltetrahydrofuran, tetrahydrofuran, and so on. Nonlimiting examples of suitable ketone-based solvents include cyclohexanone, and so on. Nonlimiting examples of suitable alcohol-based solvents include ethyl alcohol, isopropyl alcohol, and so on. Nonlimiting examples of the aprotic solvent include nitriles such as X—CN (wherein X is a C2 to C20 linear, branched, or cyclic hydrocarbon, a double bond, an aromatic ring, or an ether bond), amides (such as dimethylformamide), dioxolanes (such as 1,3-dioxolane), sulfolanes, and so on.

A single non-aqueous organic solvent may be used, or a mixture of solvents may be used. When a mixture of solvents is used, the mixture ratio may be controlled in accordance with the desirable battery performance.

The carbonate-based solvent may include a mixture of cyclic carbonates and linear carbonates. The cyclic carbonates and linear carbonates are mixed together in a volume ratio ranging from about 1:1 to about 1:9, and when the mixture is used as an electrolyte, the electrolyte performance may be enhanced.

In addition, the electrolyte may further include mixtures of carbonate-based solvents and aromatic hydrocarbon-based solvents. The carbonate-based solvents and the aromatic hydrocarbon-based solvents may be mixed together in a volume ratio ranging from about 1:1 to about 30:1.

The aromatic hydrocarbon-based organic solvent may be represented by the following Formula 27:

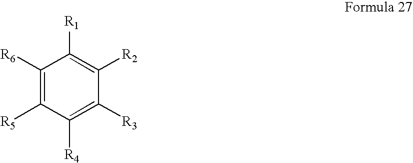

In Formula 27, each of R₁ to R₆ is independently selected from hydrogen, halogens, C1 to C10 alkyls, C1 to C10 haloalkyls, or combinations thereof.

Nonlimiting examples of suitable aromatic hydrocarbon-based organic solvents include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include an additive such as vinylene carbonate or fluoroethylene carbonate in order to improve cycle-life of the battery. The additive may be used in an appropriate amount for improving cycle-life.

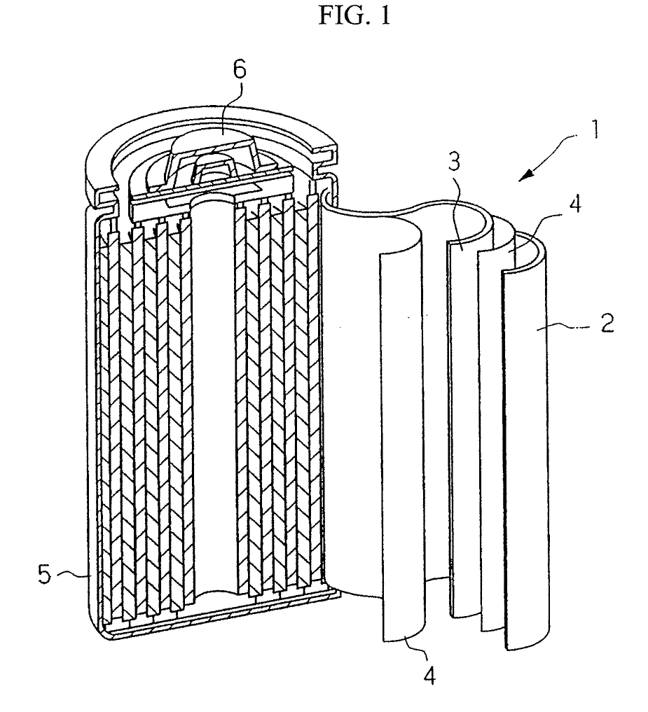

FIG. 1 shows a rechargeable lithium battery having the above-mentioned structure according to one embodiment of the present invention. FIG. 1 illustrates a cylindrical lithium ion cell 1, which includes a negative electrode 2, a positive electrode 4, a separator 3 between the negative electrode 2 and the positive electrode 4, an electrolyte impregnating the separator 3, a battery case 5, and a sealing member 6 sealing the battery case 5. The rechargeable lithium battery is not limited to the above-mentioned shape, and may be any suitable shape, such as a prism, a pouch, and so on.

The following examples are presented for illustrative purposes only, and do not limit the scope of the present invention.

### EXAMPLE 1

Si, Ti, and Ni were mixed at a ratio of 50:25:25 atomic %. The mixture was arc-melted under an argon gas atmosphere to prepare a Si—Ti—Ni alloy. The Si—Ti—Ni alloy was solidified by quenching to prepare a 50Si-50(50Ti-50Ni) negative active material for a rechargeable lithium battery cell. The 50Si-50(50Ti-50Ni) negative active material included Si active particles having an average particle size of 100 nm surrounded by a 100 nm-thick Ti—Ni metal matrix band. The quenching speed (i.e., rotating speed of the copper roll) was set at 2000 rpm.

### EXAMPLE 2

A negative active material for a rechargeable lithium battery cell was prepared as in Example 1, except that Si, Cu, Al, and Zn were used at a ratio of 50:36.3:10.665:3.035 atomic % to prepare a 50Si-50(72.6Cu-21.33Al-6.07Zn) negative active material.

### EXAMPLE 3

A negative active material for a rechargeable lithium battery cell was prepared as in Example 1, except that Si, Cu, Al, and Zn were used at a ratio of 30:55.3:14:0.7 atomic % to prepare a 30Si-70(79Cu-20Al-1Zn) negative active material.

### EXAMPLE 4

A negative active material for a rechargeable lithium battery cell was prepared as in Example 1, except that Si, Cu, Al, and W were used at a ratio of 30:15.4:53.9:0.7 atomic % to prepare a 30Si-70(22Cu-77Al-1W) negative active material.

### EXAMPLE 5

A negative active material for a rechargeable lithium battery cell was prepared as in Example 1, except that Si, Cu, Al, and V were used at a ratio of 70:12:10.5:7.5 atomic % to prepare a 70Si-30(40Cu-35Al-25V) negative active material.

### EXAMPLE 6

A negative active material for a rechargeable lithium battery cell was prepared as in Example 1, except that Si, Cu, Al, and Mn were used at a ratio of 70:16.5:12.9:0.6 atomic % to prepare a 70Si-30(55Cu-43Al-2Mn) negative active material.

### EXAMPLE 7

A negative active material for a rechargeable lithium battery cell was prepared as in Example 1, except that Si, Cu, and Al were used at a ratio of 40:30:30 atomic % to prepare a 40Si-60(50Cu-50Al) negative active material.

### EXAMPLE 8

A negative active material for a rechargeable lithium battery cell was prepared as in Example 1, except that Si, Cu, and Zn were used at a ratio of 55:17:28 atomic % to prepare a 55Si-45(37.78Cu-62.22Zn) negative active material.

### COMPARATIVE EXAMPLE 1

Si and Cu were mixed at a ratio of 4:6 atomic %. The mixture was arc-melted under an argon gas atmosphere, and thereafter solidified by quenching, preparing a Si—Cu negative active material.

### COMPARATIVE EXAMPLE 2

Si and Pb were mixed at a ratio of 7:3 atomic %. The mixture was arc-melted under an argon gas atmosphere, and thereafter solidified by quenching, preparing a Si—Pb negative active material.

### SEM Photographs of Negative Active Materials

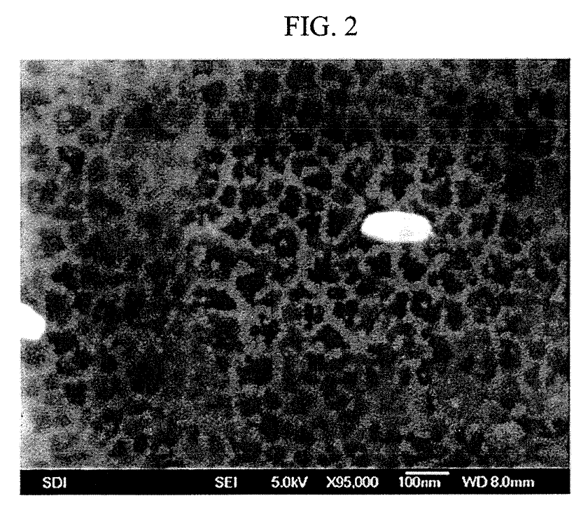

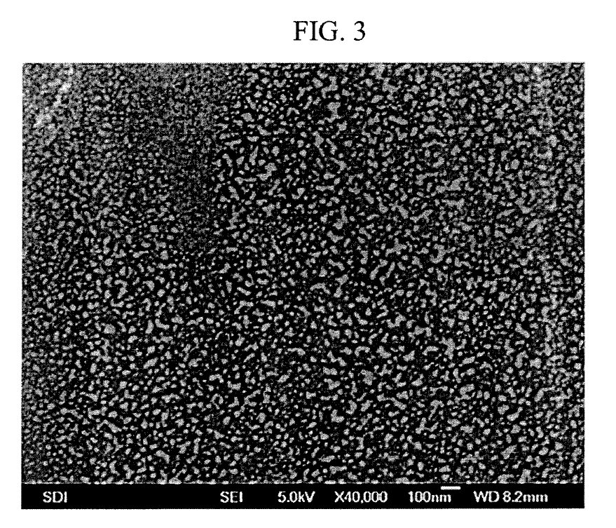

SEM photographs of the negative active materials prepared according to Examples 1 to 8 were taken. FIG. 2 is a SEM photograph (95,000-times magnification) of the negative active material according to Example 1, while FIG. 3 is a SEM photograph (40,000-times magnification) of the negative active material according to Example 2. Referring to FIGS. 2 and 3, the negative active material of Examples 1 and 2 have uniformly-formed Si active particles with an average particle size of less than 100 nm, and a Ti—Ni (FIG. 2) or Cu—Al—Zn (FIG. 3) superelastic metal matrix band with an average thickness (D) of 100 nm surrounding the Si active particles.

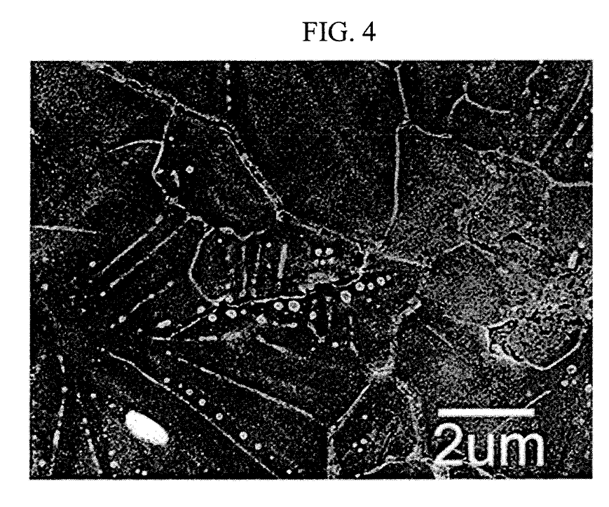

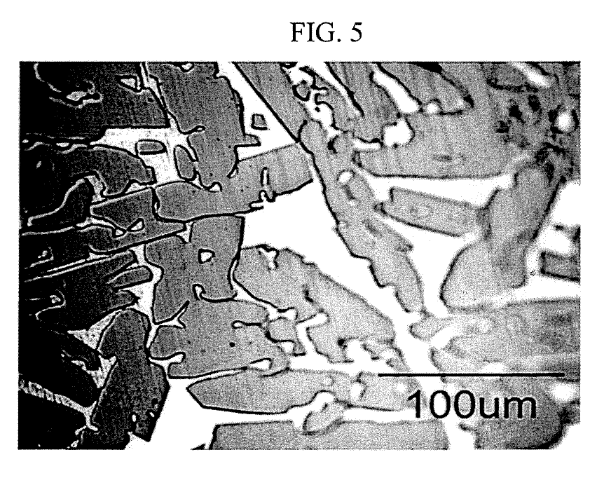

On the other hand, FIG. 4 is a SEM photograph (10,000-times magnification) of the negative active material according to Comparative Example 1, and FIG. 5 is a optical microscope photograph (200-times magnification) of the negative active material according to Comparative Example 2.

### SEM Photograph of Negative Active Material Powder

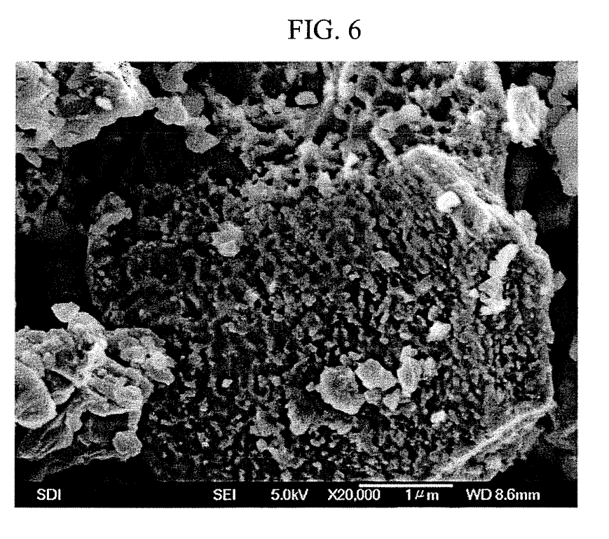

The negative active materials prepared according to Examples 1 to 8 were mechanically pulverized into powders. FIG. 6 is a SEM photograph (20,000-times magnification) of the negative active material powder according to Example 1. Referring to FIG. 6, the negative active material was solidified into a ribbon shape by quenching, but its powder had a structure of minute Si active metal particles with an average particle size of less than 100 nm and a superelastic metal matrix with an average thickness (D) of less than 100 nm uniformly surrounding the Si active metal particles. In addition, negative active material powders according to Examples 1 to 6 and 8 turned out to have the same structure.

### SEM Photograph: Examination of Negative Active Materials After Charge and Discharge

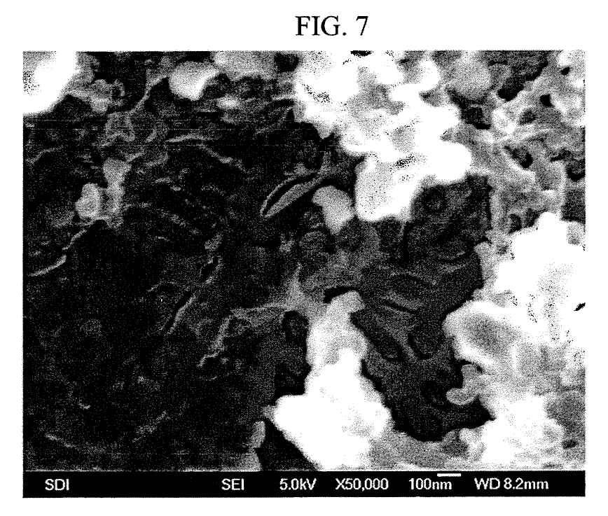

Coin cells were fabricated using the negative active material powders prepared according to Examples 1 to 8. They were charged once at 0.2 C, and then charged and discharged 100 times at 0.5 C. Then, the coin cells according to Examples 1 to 8 were disassembled to secure the negative active material powder after the 100th charge and discharge. FIG. 7 is a SEM photograph (50,000-times magnification) of the surface of the negative active material prepared according to Example 1. Referring to FIG. 7, the negative active material turned out to maintain the same structure of minute Si active metal particles with an average particle size of less than 100 nm and a superelastic metal matrix with an average thickness (D) of less than 100 nm uniformly surrounding each Si active metal particle even after the 100th charge and discharge.

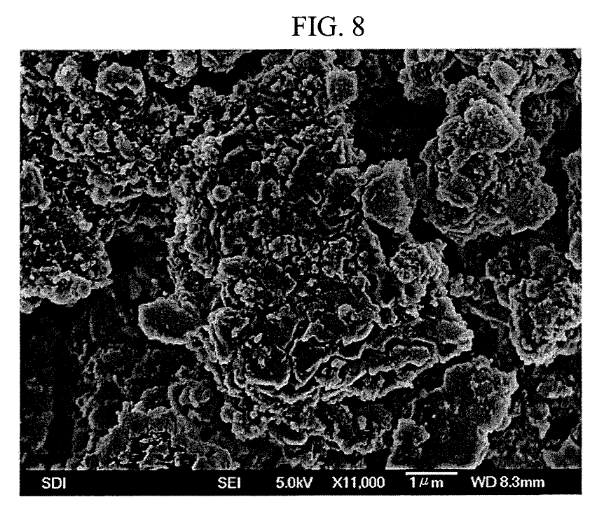

Likewise, another coin cell was fabricated using the negative active material powder prepared according to Comparative Example 1, and was charged and discharged once at 0.2 C. Then, the coin cell was disassembled to secure a negative active material after the charge and discharge. FIG. 8 is a SEM photograph (11,000-times magnification) of the surface of the negative active material prepared according to Comparative Example 1. Referring to FIG. 8, the negative active material had severe cracks despite only one charge and discharge.

### X-Ray Diffraction (XRD) Measurement

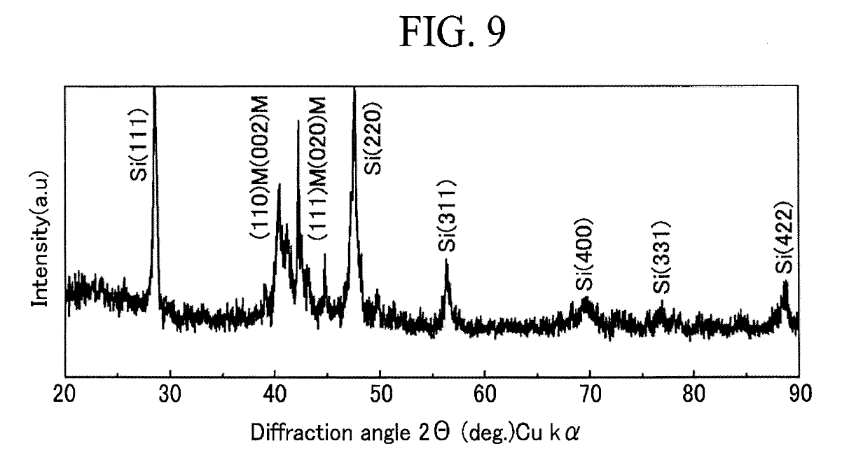

The negative active materials according to Examples 1 to 8 were measured by XRD using a CuKα ray. The results are shown in FIG. 9. Referring to FIG. 9, the negative active materials had a peak equivalent to the martensite-phase peak of a Ti—Ni alloy in addition to a Si peak. Accordingly, the negative active material turned out to have the martensite-phase of a Ti—Ni alloy. In addition, referring to the XRD measurement of the negative active materials prepared according to Examples 2 to 8, they had martensite-phase peaks corresponding to each alloy.

### Differential Scanning Calorimetry (DSC) Measurement

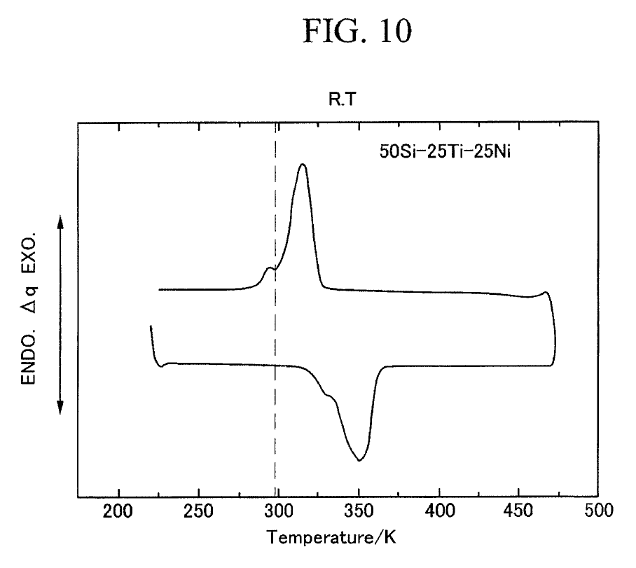

The negative active materials according to Examples 1 to 8 were measured by DSC. FIG. 10 shows the results for the negative active material prepared according to Example 1. Referring to FIG. 10, the negative active material of Example 1 had exothermic and endothermic peaks around room temperature. In FIG. 10, ENDO. denotes the endothermic peak, and EXO. denotes the exothermic peak. On the other hand, when a superelastic metal is heated up or cooled down to a threshold temperature, it may undergo a phase change. Accordingly, the negative active material turned out to include a superelastic material. In addition, referring to the DSC measurement results of the negative active materials prepared according to Examples 2 to 8, they had exothermic and endothermic peaks around room temperature. Accordingly, they turned out to include superelastic materials.

### Measurement of Capacity and Cycle-Life Characteristics

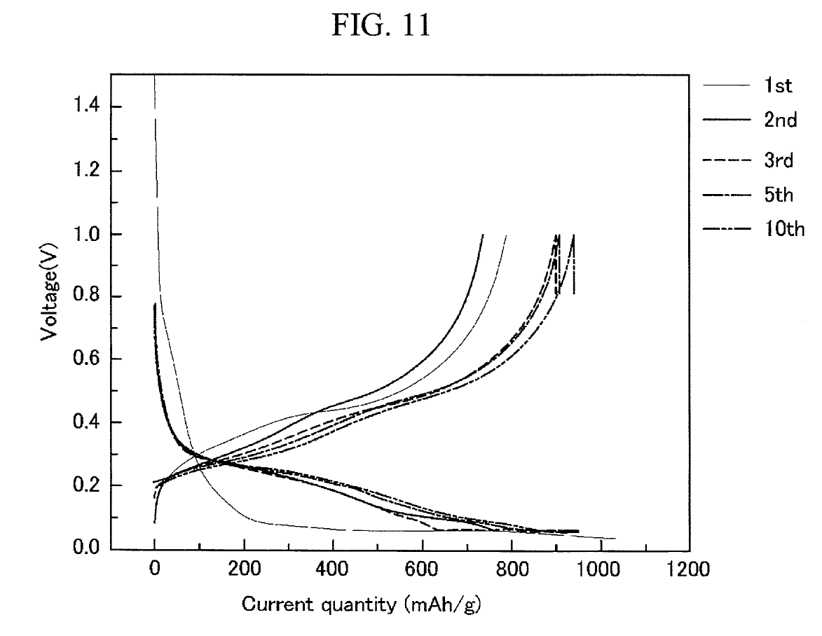

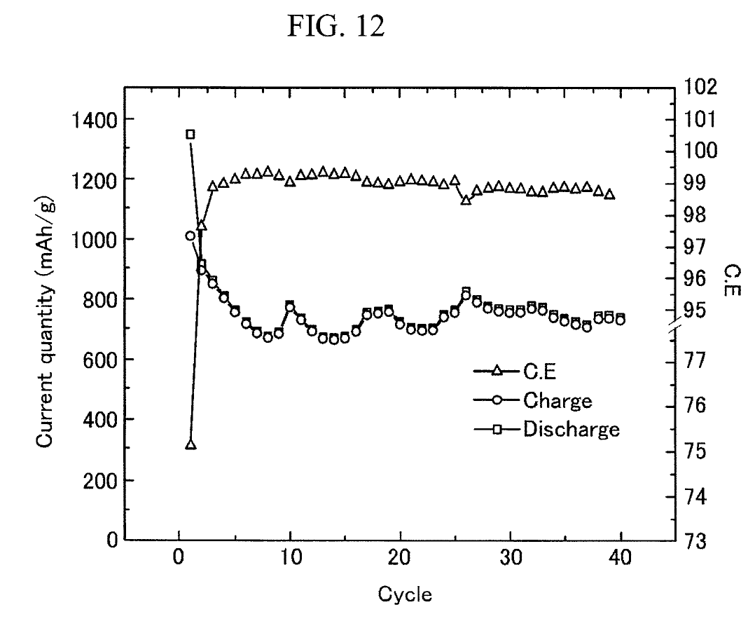

Among the ribbons solidified by quenching according to Examples 1 to 8, that of Example 1 was used to fabricate a coin cell. The coin cell was examined for capacity and cycle-life characteristics. The results are shown in FIGS. 11 and 12. FIG. 11 shows the measurements of voltage and current of a coin cell including a negative active material prepared according to Example 1 after the coin cell was repeatedly charged and discharged at a 0.1 C rate once and then at a 0.5 C rate up to 10 times. The cell maintained almost constant voltage and current, showing that it may be reversibly charged and discharged.

In FIG. 12, C.E denotes coulomb efficiency. FIG. 12 shows the change in capacity after each cycle. The coin cell including the negative active material of Example 1 was charged at 0.1 C once and then at 0.5 C up to 50 times. Based on the results, the coin cell turned out to maintain constant discharge capacity after repeated charges and discharges.

The negative active materials according to the present invention have improved battery characteristics and cycle-life.

While the present invention has been illustrated and described with reference to certain exemplary embodiments, it will be understood by those of ordinary skill in the art that various changes and modifications may be made to the described embodiments without departing from the spirit and scope of the present invention as defined by the following claims.

What is claimed is:

1. A negative active material for a rechargeable lithium battery, comprising:
at least one Si active particle; and
a metal matrix surrounding the Si active particle,
wherein the metal matrix does not react with the Si active particle, and
the negative active material has a martensite phase when X-ray diffraction intensity is measured using a CuKα ray.

2. The negative active material of claim 1, wherein the metal matrix comprises a superelastic metal alloy selected from the group consisting of Cu—Al alloys, Cu—Zn alloys, Ti—Ni alloys, and combinations thereof.

3. The negative active material of claim 2, wherein the metal matrix further comprises a transition element capable of maintaining a superelasticity of the superelastic metal alloy.

4. The negative active material of claim 3, wherein the transition element is selected from the group consisting of Ga, Ti, V, Cr, Mn, Fe, Co, Ni, Cu, Zn, Ru, Rh, Pd, W, Re, Os, Ir, Au, and combinations thereof.

5. The negative active material of claim 1, wherein the Si active particle and the metal matrix form an alloy.

6. The negative active material of claim 5, wherein the alloy is represented by Formula 1:
xSi-y(aα-bβ-cγ) Formula 1
wherein:
x ranges from about 30 to about 70 atomic %,
y ranges from about 30 to about 70 atomic %,
x+y is 100 atomic %,
α is Cu or Ti,
β is Al or Zn when α is Cu, and β is Ni when α is Ti,
γ is a transition element selected from the group consisting of Ga, Ti, V, Cr, Mn, Fe, Co, Ni, Cu, Zn, Ru, Rh, Pd, W, Re, Os, Ir, Au, and combinations thereof,
a ranges from about 20 to about 80 atomic %,
b ranges from about 20 to about 80 atomic %,
c ranges from about 0 to about 25 atomic %, and
a+b+c is 100 atomic %.

7. The negative active material of claim 1, wherein the metal matrix is present in an amount ranging from about 30 to about 70 atomic %.

8. The negative active material of claim 7, wherein the metal matrix is present in an amount ranging from about 30 to about 50 atomic %.

9. The negative active material of claim 1, wherein the Si active particle is present in an amount ranging from about 30 to about 70 atomic %.

10. The negative active material of claim 9, wherein the Si active particle is present in an amount ranging from about 50 to about 70 atomic %.

11. The negative active material of claim 1, wherein the metal matrix is band-shaped and has an average thickness ranging from about 10 to about 100 nm.

12. The negative active material of claim 11, wherein the metal matrix is band-shaped and has an average thickness ranging from about 20 to about 50 nm.

13. The negative active material of claim 1, wherein the Si active particle has an average particle size ranging from about 10 to about 100 nm.

14. The negative active material of claim 13, wherein the Si active particle has an average particle size ranging from about 10 to about 30 nm.

15. A rechargeable lithium battery comprising:
a negative electrode comprising:
a negative active material comprising:
at least one Si active particle, and
a metal matrix surrounding the Si active particle,
wherein the metal matrix does not react with the Si active particle, and the negative active material has a martensite phase when X-ray diffraction intensity is measured using a CuKα ray;
a positive electrode comprising a positive active material capable of reversibly intercalating and deintercalating lithium ions; and
an electrolyte.

16. The rechargeable lithium battery of claim 15, wherein the metal matrix comprises a superelastic metal alloy selected from the group consisting of Cu—Al alloys, Cu—Zn alloys, Ti—Ni alloys, and combinations thereof.

17. The rechargeable lithium battery of claim 15, wherein the metal matrix further comprises a transition element capable of maintaining a superelasticity of the superelastic metal alloy.

18. The rechargeable lithium battery of claim 17, wherein the transition element is selected from the group consisting of Ga, Ti, V, Cr, Mn, Fe, Co, Ni, Cu, Zn, Ru, Rh, Pd, W, Re, Os, Ir, Au, and combinations thereof.

19. The rechargeable lithium battery of claim 15, wherein the Si active particle and the metal matrix form an alloy.

20. The rechargeable lithium battery of claim 19, wherein the alloy is represented by Formula 1:
xSi-y(aα-bβ-cγ) Formula 1
wherein:
x ranges from about 30 to about 70 atomic %,
y ranges from about 30 to about 70 atomic %,
x+y is 100 atomic %,
α is Cu or Ti,
β is Al or Zn when α is Cu, and β is Ni when α is Ti,
γ is a transition element selected from the group consisting of Ga, Ti, V, Cr, Mn, Fe, Co, Ni, Cu, Zn, Ru, Rh, Pd, W, Re, Os, Ir, Au, and combinations thereof,
a ranges from about 20 to about 80 atomic %,
b ranges from about 20 to about 80 atomic %,
c ranges from about 0 to about 25 atomic %, and
a+b+c is 100 atomic %.

21. The rechargeable lithium battery of claim 15, wherein the metal matrix is present in an amount ranging from about 30 to about 70 atomic %.

22. The rechargeable lithium battery of claim 21, wherein the metal matrix is present in an amount ranging from about 30 to about 50 atomic %.

23. The rechargeable lithium battery of claim 15, wherein the Si active particle is present in an amount ranging from about 30 to about 70 atomic %.

24. The rechargeable lithium battery of claim 23, wherein the Si active particle is present in an amount ranging from about 50 to about 70 atomic %.

25. The rechargeable lithium battery of claim 15, wherein the metal matrix is band-shaped and has an average thickness ranging from about 10 to about 100 nm.

26. The rechargeable lithium battery of claim 25, wherein the metal matrix is band-shaped and has an average thickness ranging from about 20 to about 50 nm.

27. The rechargeable lithium battery of claim 15, wherein the Si active particle has an average particle size ranging from about 10 to about 100 nm.

28. The rechargeable lithium battery of claim 27, wherein the Si active particle has an average particle size ranging from about 10 to about 30 nm.
